(19) United States
(12) Patent Application Publication
(10) Pub. No.: US 2013/0278432 A1
(43) Pub. Date: Oct. 24, 2013

(54) Simultaneous Data Transmission of Multiple Nodes

(71) Applicant: HALLIBURTON ENERGY SERVICES, INC., Houston, TX (US)

(72) Inventors: Zeke Shashoua, Dallas, TX (US); Kevin Fink, Frisco, TX (US)

(73) Assignee: Halliburton Energy Services, Inc., Houston, TX (US)

(21) Appl. No.: 13/850,740

(22) Filed: Mar. 26, 2013

(30) Foreign Application Priority Data
Apr. 23, 2012 (US) PCT/US2012/034614

(51) Int. Cl. G01V 3/18

(52) U.S. Cl. CPC G01V 3/18
USPC 340/853.7

(57) ABSTRACT

Systems and methods of communicating wellbore data are disclosed. One method includes transmitting a first uplink signal with a downhole transceiver to a plurality of repeaters communicably coupled to the downhole transceiver, the plurality of repeaters including individual repeaters axially spaced from each other along a length of a pipe string. The first uplink signal is successively transmitted through the individual repeaters, and a second uplink signal is then transmitted with the downhole transceiver to the plurality of repeaters wherein the individual repeaters again successively transmit the second uplink signal. The first and second uplink signals are simultaneously transmitted through the plurality of repeaters, but transmission of the first uplink signal precedes transmission of the second uplink signal. The first and second uplink signals are eventually received with a surface transceiver in communication with the plurality of repeaters.

### CROSS REFERENCE TO RELATED APPLICATIONS

The present application is a continuation of and claims priority to International Application No. PCT/US2012/034614 filed on Apr. 23, 2012 under 35 U.S.C. §365(a) and §119.

### BACKGROUND

The disclosure relates generally to wellbore communication systems and, more particularly, to data transmission systems and methods for communicating between a wellbore and the surface.

Modern hydrocarbon drilling and production operations demand the transfer of a great quantity of information relating to parameters and conditions present in the downhole environment. Such information typically includes characteristics of the earth formations traversed by the borehole, data relating to the size and configuration of the borehole itself, pressures and temperatures of ambient downhole fluids, and other vital downhole parameters. In response to this information, operators are able to assess the current situation and take any necessary action to maintain the integrity of the well.

A variety of communication and transmission techniques have been attempted to provide real time data from the bottom of the wellbore to the surface. Currently, there are four major categories of telemetry systems used: acoustic waves, mud pressure pulses, insulated conductors, and electromagnetic waves. In acoustic telemetry systems, for example, an acoustic signal is typically generated near the bottom of the borehole and is transmitted through the pipe string to an acoustic receiver arranged at the surface. The acoustic signal is sequentially transmitted in the form of pulse vibrations generated by spaced acoustic transceivers or repeaters that are strategically placed along the length of the pipe string at predetermined locations.

Currently, data relayed from the bottom of the well must reach the surface before the next message from the bottom of the well can begin to be transmitted. This is done in order to avoid potential acoustic collision of transmitted messages that commonly results when two acoustic signals are detected by a single repeater. When acoustic collision occurs, the data eventually retrieved at the surface oftentimes is revealed as useless noise. Depending on the depth of the well, the amount of data being transmitted, and the relative transmission speed (bit rate) of the repeaters, a significant amount of time may be required for the acoustic signal to actually reach the surface. For example, a message with a large amount of data transmitted at a slow speed from the bottom of the well to the surface may take close to an hour to reach the surface in some cases. Getting data from source to destination at faster speeds enables the operator to take quick action and control the current situation for both emergency and normal operation.

### SUMMARY OF THE INVENTION

The disclosure relates generally to wellbore communication systems and, more particularly, to data transmission systems and methods for communicating between a wellbore and the surface.

In some embodiments, the present invention provides a telemetry communication system for communicating wellbore data. The system may include a downhole transceiver coupled to a pipe string and arranged within a wellbore. The downhole transceiver may be configured to retrieve wellbore data and transmit a first uplink signal corresponding to a first component of the wellbore data and a second uplink signal corresponding to a second component of the wellbore data. The system also includes a plurality of repeaters coupled to the pipe string and in communication with the downhole transceiver. The plurality of repeaters may be configured to receive and simultaneously transmit the first and second uplink signals, wherein transmission of the first uplink signal successively precedes transmission of the second uplink signal through the plurality of repeaters. The system may further include a surface transceiver in communication with the plurality of repeaters and configured to receive the first and second uplink signals.

In some aspects of the disclosure, a method for communicating wellbore data is disclosed. The method may include transmitting a first uplink signal with a downhole transceiver coupled to a pipe string arranged within a wellbore. The first uplink signal may correspond to a first component of the wellbore data. The method may also include receiving the first uplink signal with a first repeater communicably coupled to the downhole transceiver, and transmitting the first uplink signal with the first repeater to a second repeater communicably coupled to the first repeater. The method may further include transmitting a second uplink signal with the downhole transceiver to the first repeater. The second uplink signal may correspond to a second component of the wellbore data. The method may even further include receiving the first and second uplink signals with a surface transceiver in communication with the first and second repeaters. The first and second uplink signals may be simultaneously transmitted between the downhole transceiver and the surface transceiver and transmission of the first uplink signal successively precedes transmission of the second uplink signal.

In some aspects of the disclosure, another method for communicating wellbore data is disclosed. The method may include transmitting a first uplink signal with a downhole transceiver to a plurality of repeaters communicably coupled to the downhole transceiver. The plurality of repeaters may be individual repeaters axially spaced from each other along a length of a pipe string arranged within a wellbore. The method may also include successively transmitting the first uplink signal through the individual repeaters, transmitting a second uplink signal with the downhole transceiver to the plurality of repeaters, and successively transmitting the second uplink signal through the individual repeaters.

The first and second uplink signals may be simultaneously transmitted through the plurality of repeaters and transmission of the first uplink signal may precede transmission of the second uplink signal. The method may further include receiving the first and second uplink signals with a surface transceiver in communication with the plurality of repeaters.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a semi-submersible offshore oil and gas platform that uses an exemplary telemetry communication system, according to one or more embodiments disclosed.

FIG. 2 illustrates a progressive view of a method for communicating uplink signals to a surface, according to one or more embodiments.

FIG. 3 illustrates another progressive view of a method for communicating uplink signals to a surface, according to one or more embodiments.

FIG. 4 illustrates a computer system suitable for implementing one or more of the embodiments of the disclosure.

### DETAILED DESCRIPTION

The disclosure relates generally to wellbore communication systems and, more particularly, to data transmission systems and methods for communicating between a wellbore and the surface.

The disclosure provides a method to increase the data rate of various data communications of acoustic, electromagnetic, and other telemetry media that use peer-to-peer or repeater-based data communication systems. In order to receive more data from downhole sensors at a faster rate, embodiments disclosed herein provide systems and methods of simultaneous data transmission of data messages across multiple repeaters. As discussed in more detail below, the multiple repeaters may be used to simultaneously transmit distinct data messages, and thereby significantly increase the amount of messages and data transmitted from the bottom of the wellbore and to the surface over a given time span. As will be appreciated, faster data retrieval allows an operator to take quicker action and control of emerging situations.

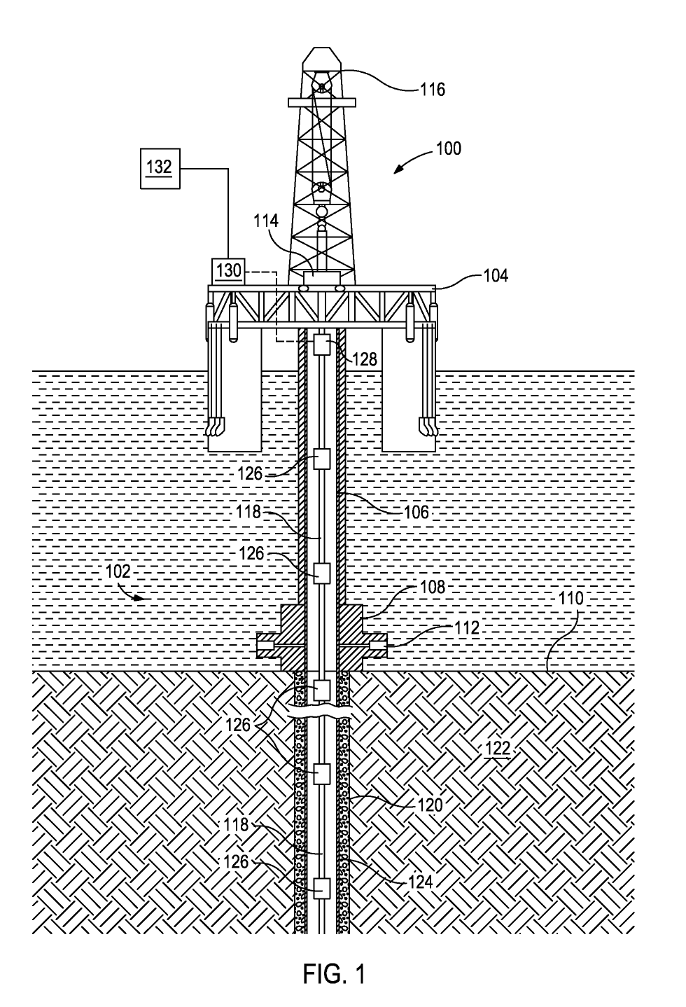

Referring to FIG. 1, illustrated is an offshore oil and gas platform 100 that may be configured to use an exemplary telemetry communication system 102, according to one or more embodiments of the disclosure. It should be noted that, even though FIG. 1 depicts an offshore oil and gas platform 100, it will be appreciated by those skilled in the art that the exemplary telemetry communication system 102, and its various embodiments disclosed herein, are equally well suited for use in or on other types of oil and gas rigs, such as land-based oil and gas rigs or rigs arranged in any other geographical location. The platform 100 may be a semi-submersible platform 104 having a subsea conduit 106 extending from the platform 104 to a wellhead installation 108 arranged on the sea floor 110. The wellhead installation 108 may include one or more blowout preventers 112. The platform 104 has a hoisting apparatus 114 and a derrick 116 for raising and lowering a pipe string 118. The term “pipe string,” as used herein, may refer to one or more types of connected lengths of tubulars as known in the art, and may include, but is not limited to, drill string, landing string, production tubing, combinations thereof, or the like.

A wellbore 120 extends below the wellhead installation 108 and has been drilled through various earth strata 122, including one or more oil and gas formations (not shown). A casing string 124 may be cemented within the wellbore 120. The term “casing” is used herein to designate a tubular string used to line a wellbore. Casing may actually be of the type known to those skilled in the art as “liner” and may be made of any material, such as steel or composite materials and may be segmented or continuous, such as coiled tubing.

Although FIG. 1 depicts a vertical section of the wellbore 120, the present disclosure is equally applicable for use in wellbores having other directional configurations including horizontal wellbores, deviated wellbores, slanted wellbores, combinations thereof, and the like. Moreover, use of directional terms such as above, below, upper, lower, upward, downward, uphole, downhole, and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe or bottom of the well.

As illustrated in FIG. 1, the telemetry communication system 102 may be characterized as a wireless communication system employing, for example, various acoustic telemetry components. It will be appreciated, however, that the telemetry communication system 102 may equally be employed in conjunction with other telemetry media such as, but not limited to, electromagnetic, mud pulse, insulated conductors, combinations thereof, and the like.

The telemetry communication system 102 may include a plurality of wireless inline repeaters 126 and a surface transceiver 128. The repeaters 126 may be coupled or otherwise attached to the pipe string 118 and spaced apart from one another by a predetermined distance. The distance between adjacent repeaters 126 may be dependent on several factors including, but not limited to, the material of the pipe string 118, what downhole operation is being undertaken (e.g., cementing, drilling, production, etc.), location of the wellbore 120 (e.g., subsea, land-based, etc.), whether there is heavy equipment in the general area of the particular repeater 126 which could generate noise and/or vibration, whether the pipe string 118 is in tension or compression in the general area of the particular repeater 126, etc. Accordingly, the distance between adjacent repeaters 126 varies depending on the local factors encountered downhole.

The repeaters 126 are configured to receive and transmit data along the length of the pipe string 118 and communicate with the surface transceiver 128. In some embodiments, the repeaters 126 may be uni-directional repeaters, i.e., configured to only send uplink signals or only send downlink signals. In other embodiments, however, the repeaters 126 may be bi-directional, i.e., configured to receive uplink and downlink telemetry signals. As used herein, the term “uplink” refers to telemetry signals generally directed towards the surface (i.e., the offshore rig installation 100). Conversely, the term “downlink” refers to signals generally directed towards the bottom of the wellbore 120 and/or the end of the pipe string 118. In at least one embodiment, one or more of the repeaters 126 may be a repeater such as is described in co-owned U.S. Pat. No. 8,040,249 entitled “Acoustic Telemetry Transceiver,” the contents of which are hereby incorporated by reference to the extent not inconsistent with the present disclosure.

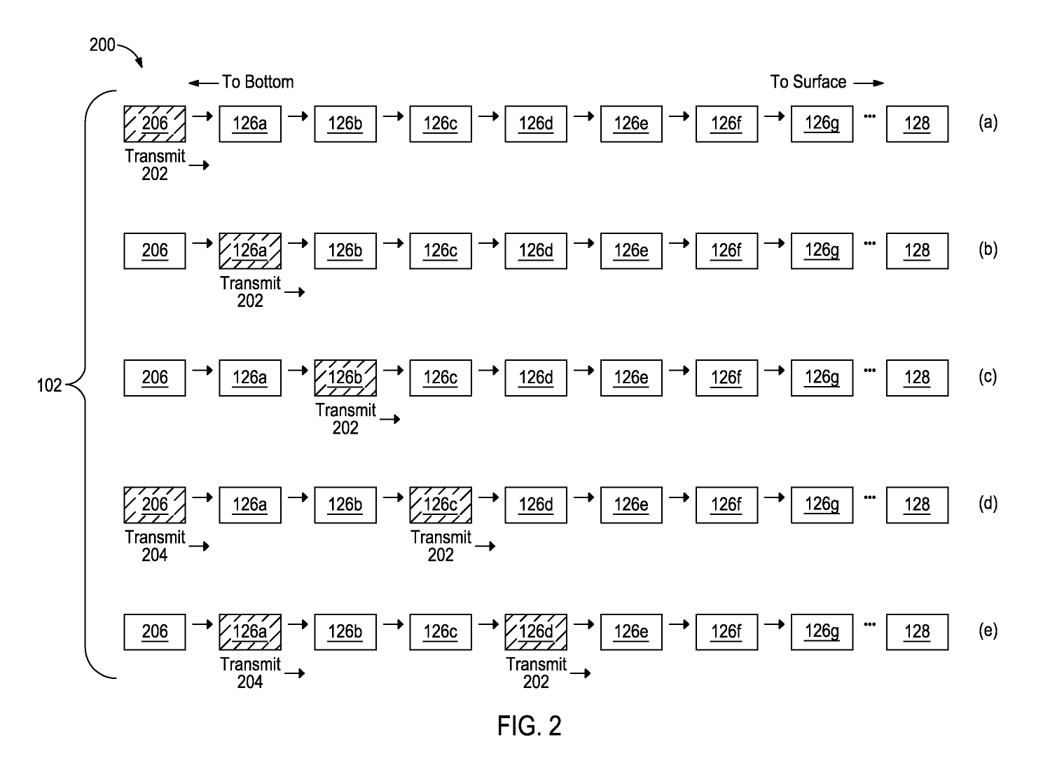

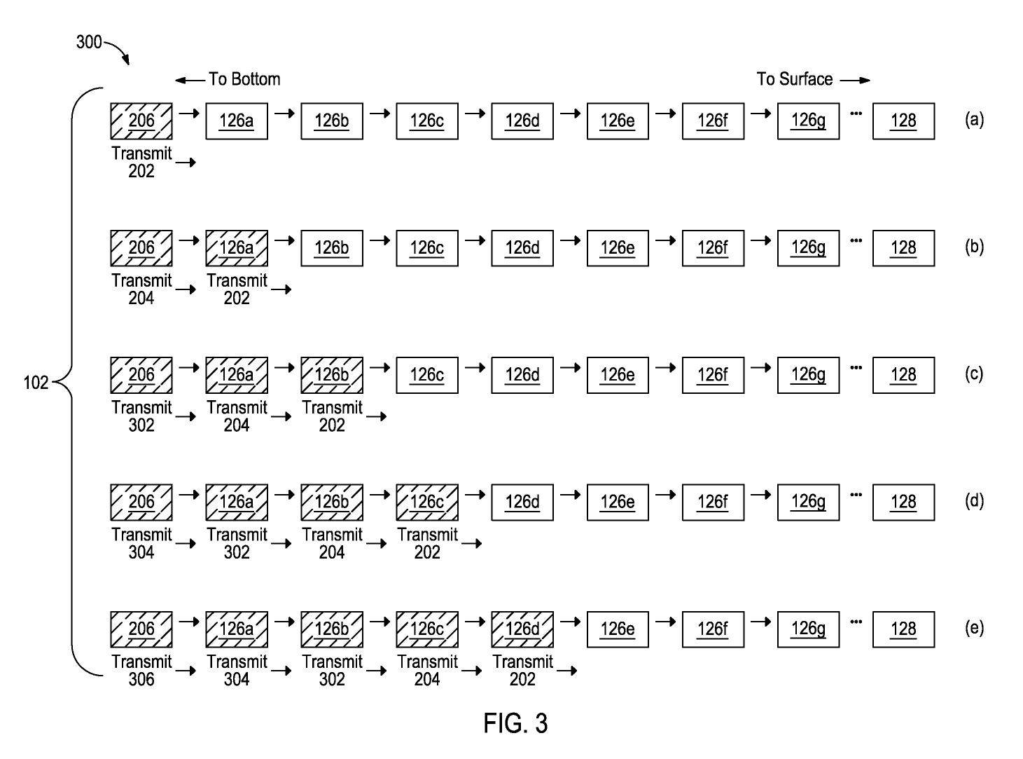

In operation, the telemetry communication system 102 may be configured to ascertain and transmit pertinent wellbore data via an uplink transmission. The pertinent wellbore data may include, but is not limited to, downhole pressure and temperature conditions, various characteristics of the subsurface formations (e.g., resistivity, density, porosity, etc.), characteristics of the wellbore 120 (e.g., size, shape, etc.), etc. As used herein, however, wellbore data is not limited to data concerning only the wellbore 120 itself, but also encompasses data corresponding to conditions or physical parameters of the pipe string 118, the location of tubing and/or casing collars, the location of radioactive tags, tool diagnostic and/or health information, or any other data parameter able to be transmitted uphole or downhole. The wellbore data may first be collected and recorded using one or more downhole sensors (not shown), as are known in the art. The collected data is transmitted as uplink data using, for example, a downhole transceiver 206 (shown in FIGS. 2 and 3) configured to modulate the data into an uplink signal, such as an acoustic signal, that is transmittable along the pipe string 118 and received by an axially adjacent first wireless inline repeater 126. As will be appreciated, besides acoustic signals, it is also contemplated herein that the downhole transceiver 206 be configured to alternatively send other types of telemetry signals, without departing from the scope of the disclosure. For purposes of simplicity, however, acoustic telemetry methods will be described with reference to the telemetry communication system 102.

The first wireless inline repeater 126 may detect and demodulate the acoustic signal received from the downhole transceiver 206 (FIGS. 2 and 3). As part of the demodulation process, the first wireless inline repeater 126 may perform amplification, filtering, analog-to-digital conversion, buffering, and/or error correction on the received data. The first wireless inline repeater 126 then transmits the acoustic uplink data as a new acoustic uplink signal to a succeeding, axially-adjacent second wireless inline repeater 126 or alternatively, depending on its relative position on the pipe string 118, to the surface transceiver 128 arranged at the surface. In order to receive and likewise transmit the received acoustic uplink signal from a preceding wireless inline repeater 126, each wireless inline repeater 126 may be equipped with an acoustic telemetry receiver, similar to the surface transceiver 128, and an acoustic transducer configured to generate modulated acoustic vibrations on the pipe string 118. Moreover, each repeater 126 may be configured to receive data across one frequency, but transmit data across an entirely different or distinct frequency using one or more band-pass filters known in the art. As a result, the repeaters 126 may be designed to avoid acoustic collision during the simultaneous receipt and transmit processes in each respective repeater 126. In other embodiments, however, the repeaters 126 may nonetheless be configured to receive and transmit data across the same frequency, without departing from the scope of the disclosure.

The surface transceiver 128 may include one or more accelerometers or other acoustic sensors coupled to the pipe string 118 and used to detect and receive the acoustic uplink signal being transmitted via the wireless inline repeaters 126. The surface transceiver 128 then forwards the detected data to a demodulator 130 which demodulates the received data and transmits it to computing equipment 132 communicably coupled thereto. The computing equipment 132 may be configured to analyze the received data and extract the pertinent wellbore data. As a result, real-time wellbore 120 parameters may be viewed and considered by rig operators. Any downlink signals sent from the surface transceiver 128 may be handled in substantially the same fashion as the uplink signal, and therefore will not be described in detail.

Referring now to FIG. 2, with continued reference to FIG. 1 and including subfigures (a) through (e), illustrated is an exemplary progressive method 200 of simultaneous transmission of multiple uplink signals using the exemplary telemetry communication system 102, according to one or more embodiments disclosed. Although FIG. 2 depicts transmission of multiple “uplink” signals, those skilled in the art will readily recognize that the embodiments disclosed herein are equally applicable to the transmission of multiple “downlink” signals. As illustrated, FIGS. 2(a)-(e) show the progression of a first uplink signal 202 and a second uplink signal 204 as they are transmitted and received through multiple wireless inline repeaters 126a-g configured to function in concert. As briefly discussed above, the telemetry communication system 102 may include a downhole transceiver 206 configured to retrieve wellbore data from one or more downhole sensors (not shown). The first uplink signal 202 may correspond to a first component of the wellbore data and the second uplink signal may correspond to a second component of the wellbore data. The downhole transceiver 206, the wireless inline repeaters 126a-g, and the surface transceiver 128 may all be communicably coupled such that they are configured to operate in concert or otherwise selectively synchronize the transmission of the uplink signals 202, 204.

It will be appreciated that whereas only first and second uplink signals 202, 204 are shown in FIG. 2, the method 200 may be applicable to more than two uplink signals, without departing from the scope of the disclosure. Moreover, while not specifically shown, it will also be appreciated that the downhole transceiver 206 and each repeater 126a-g may be sequentially coupled or otherwise attached to the pipe string 118 in order to successively transmit the first and second uplink signals 202, 204 until eventually reaching the surface transceiver 128.

In one or more embodiments, the downhole transceiver 206 may be configured to modulate the retrieved wellbore data into an uplink signal, such as the first and second uplink signals 202, 204. In at least one embodiment, the first and second uplink signals 202, 204 may be transmitted by the downhole transceiver 206 as corresponding acoustic signals to be received by an axially adjacent repeater, such as the first repeater 126a. As will be appreciated, however, the first and second uplink signals 202, 204 may be characterized as other types of telemetry signals such as, but not limited to, electromagnetic signals, ultrasonic signals, radio frequency signals, optical signals, and/or sonic signals, without departing from the scope of the disclosure.

During receipt and modulation of the first uplink signal 202, the downhole transceiver 206 may be configured to determine the size of the first uplink signal 202; i.e., how many bits of data the first uplink signal 202 consists of. Moreover, the downhole transceiver 206 may be programmed with or is otherwise periodically updated on the relative transmission speed of each repeater 126a-g; i.e., how many bits per second of data each repeater 126a-g is able to transmit. Consequently, the downhole transceiver 206 may be able to determine how fast the first uplink signal 202 will be able to reach the surface transceiver 128 once transmitted from the downhole transceiver 206.

More importantly, however, for the purposes of this disclosure, the downhole transceiver 206 may be configured to determine when a succeeding repeater 126a-g may be able to receive a second transmitted signal (e.g., the second uplink signal 204) without risking acoustic collision with a preceding transmitted signal (e.g., the first uplink signal 202). Accordingly, per the determination and/or calculation made by the downhole transceiver 206 regarding the transmission capabilities of the telemetry communication system 102, distinct uplink signals containing discrete wellbore data may be transmitted simultaneously to the surface transceiver 128.

Referring to FIG. 2(a), the downhole transceiver 206 modulates and transmits the first uplink signal 202 to the first repeater 126a. In FIG. 2(b), the first repeater 126a receives and transmits the first uplink signal 202 to the second repeater 126b. In FIG. 2(c), the second repeater 126b receives and transmits the first uplink signal 202 to the third repeater 126c. In FIG. 2(d), the third repeater 126c receives and transmits the first uplink signal 202 to the fourth repeater 126d. In at least one embodiment, at this point the downhole transceiver 206 may be configured to modulate and transmit the second uplink signal 204 to the first repeater 126. For example, as depicted in FIG. 2(e), the fourth repeater 126d receives and transmits the first uplink signal 202 to the fifth repeater 126e while the first repeater 126 simultaneously receives and transmits the second uplink signal 204 to the second repeater 126b.

Accordingly, the first and second uplink signals 202, 204 may be simultaneously transmitted to the surface transceiver 128, but separated by a distance of three repeaters 126. As a result, acoustic collision between the distinct signals 202, 204 is avoided, while significantly increasing the amount of messages/data that can be transmitted from the downhole transceiver 206 to the surface transceiver 128 over a given time span. In the event that the first uplink signal 202 is a larger data file than the second uplink signal 204, and therefore requires more time to transmit between adjacent repeaters 126a-b, the telemetry communication system 102 may be configured to delay the transmission of the second uplink signal 204 for a sufficient amount of time such that the second uplink signal 204 does not catch up or otherwise acoustically collide with the first uplink signal 202. In one embodiment, for example, the downhole transceiver 206 may be configured to delay the initial transmission of the second uplink signal 204 such that acoustic collision is avoided. In other embodiments, however, each repeater 126a-g may be configured to individually delay transmission of the second uplink signal 204 to accomplish the same end.

It will be appreciated, however, that additional uplink signals, besides the first and second uplink signals 202, 204, may be transmitted simultaneously with the first and second uplink signals 202, 204, thereby further increasing the amount of wellbore data transmitted to the surface transceiver 128 over a given time span. For example, once the first uplink signal 202 is received by the sixth repeater 126f and the second uplink signal 204 is received by the third repeater 126c, the downhole transceiver 206 may be configured to retrieve and modulate a third uplink signal (not shown) in preparation for its transmission to the first repeater 126a simultaneously with the transmission of the first and second uplink signals 202, 204. As can be appreciated, more than three uplink signals may be transmitted simultaneously toward the surface transceiver 128, without departing from the scope of the disclosure. Moreover, it is noted that the distance between the first and second uplink signals 202, 204 may be separated by a distance of more or less than three repeaters 126, without departing from the scope of the disclosure.

Referring now to FIG. 3, with continued reference to FIG. 1 and including subfigures (a) through (e), illustrated is another exemplary progressive method 300 of simultaneous transmission of multiple uplink signals using the exemplary telemetry communication system 102, according to one or more embodiments. The progressive method 300 may be similar in some respects to the progressive method 200 described above with reference to FIG. 2. Accordingly, the method 300 may be best understood with reference to FIG. 2, where like numerals indicate like elements that will not be described again in detail.

The method 300 illustrates the simultaneous transmission of multiple uplink signals where each uplink signal is separated by a distance of only one repeater 126. Specifically, FIGS. 3(a)-(e) show the progression of the first uplink signal 202, the second uplink signal 204, a third uplink signal 302, a fourth uplink signal 304, and a fifth uplink signal 306, as they are each transmitted and received through the multiple wireless inline repeaters 126a-g communicably coupled within the telemetry communication system 102. As the first and second uplink signals 202, 204 may correspond to first and second components of wellbore data, likewise, the third, fourth, and fifth uplink signals 302, 304, 306 may correspond to third, fourth, and fifth components, respectively, of wellbore data. In at least one embodiment, the respective components of wellbore data in each uplink signal 202, 204, 302, 304, 306 may or may not be the same type of wellbore data. In order to prevent acoustic collision with adjacent uplink signals, each repeater 126a-g may be configured to receive data across one acoustic frequency, but transmit data across an entirely different or distinct acoustic frequency. Such function can be accomplished using one or more band-pass filters, as known in the art.

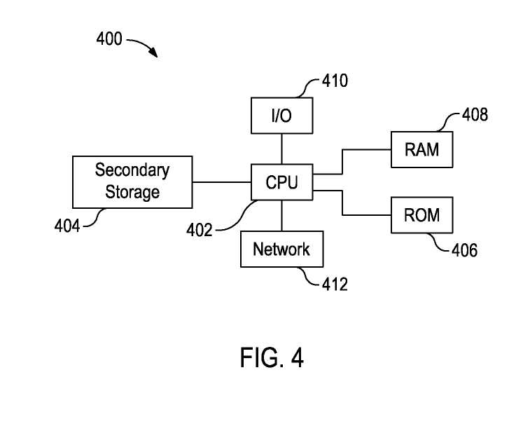

FIG. 4 illustrates a computer system 400 suitable for implementing one or more of the exemplary embodiments disclosed herein. The computer system 400 includes a processor 402 (which may be referred to as a central processor unit or CPU) that is in communication with memory devices including secondary storage 404, read only memory (ROM) 406, random access memory (RAM) 408, input/output (I/O) devices 410, and network connectivity devices 412. The processor 402 may be implemented as one or more CPU chips.

It is understood that by programming and/or loading executable instructions onto the computer system 400, at least one of the CPU 402, the RAM 408, and the ROM 406 are changed, transforming the computer system 400 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 404 may include one or more disk drives or tape drives and is used for non-volatile storage of data and as an over-flow data storage device if RAM 408 is not large enough to hold all working data. Secondary storage 404 may be used to store programs which are loaded into RAM 408 when such programs are selected for execution. The ROM 406 is used to store instructions and perhaps data which are read during program execution. ROM 406 is a non-volatile memory device which typically has a small memory capacity relative to the larger memory capacity of secondary storage 404. The RAM 408 is used to store volatile data and perhaps to store instructions. Access to both ROM 406 and RAM 408 is typically faster than to secondary storage 404.

Exemplary I/O devices 410 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 412 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), and/or worldwide interoperability for microwave access (WiMAX) radio transceiver cards, and other well-known network devices. These network connectivity devices 412 may enable the processor 402 to communicate with an Internet or one or more intranets. With such a network connection, it is contemplated that the processor 402 might receive information from the network, or might output information to the network in the course of performing the above-described method steps. Such information, which is often represented as a sequence of instructions to be executed using processor 402, may be received from and outputted to the network, for example, in the form of a computer data signal embodied in a carrier wave.

Such information, which may include data or instructions to be executed using processor 402, for example, may be received from and outputted to the network, for example, in the form of a computer data baseband signal or signal embodied in a carrier wave. The baseband signal or signal embodied in the carrier wave generated by the network connectivity devices 412 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 402 executes instructions, codes, computer programs, scripts which it accesses from hard disk, floppy disk, optical disk (these various disk based systems may all be considered secondary storage 404), ROM 406, RAM 408, or the network connectivity devices 412. While only one processor 402 is shown, multiple processors may be present. Thus, while instructions may be discussed as executed by a processor, the instructions may be executed simultaneously, serially, or otherwise executed by one or multiple processors.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A telemetry communication system for communicating wellbore data, comprising:
a downhole transceiver coupled to a pipe string and arranged within a wellbore, the downhole transceiver being configured to retrieve wellbore data and transmit a first uplink signal corresponding to a first component of the wellbore data and a second uplink signal corresponding to a second component of the wellbore data;
a plurality of repeaters coupled to the pipe string and in communication with the downhole transceiver, the plurality of repeaters being configured to receive and simultaneously transmit the first and second uplink signals, wherein transmission of the first uplink signal successively precedes transmission of the second uplink signal through the plurality of repeaters;
a surface transceiver in communication with the plurality of repeaters and configured to receive the first and second uplink signals.

2. The system of claim 1, wherein the first and second uplink signals are separated by one or more repeaters of the plurality of repeaters.

3. The system of claim 1, wherein the first and second uplink signals are separated by a single repeater of the plurality of repeaters.

4. The system of claim 1, wherein the first and second uplink signals are acoustic signals.

5. The system of claim 4, wherein the plurality of repeaters are configured to receive the first and second uplink signals across a first acoustic frequency and transmit the first and second uplink signals across a second acoustic frequency, the first acoustic frequency being different than the second acoustic frequency.

6. The system of claim 4, wherein the plurality of repeaters are configured to receive the first and second uplink signals across a first acoustic frequency and transmit the first and second uplink signals across a second acoustic frequency, the first acoustic frequency being the same as the second acoustic frequency.

7. The system of claim 1, wherein the first and second uplink signals are electromagnetic signals.

8. The system of claim 1, wherein the downhole transceiver, the plurality of repeaters, and the surface transceiver are communicably coupled to facilitate the synchronization of the transmission of the first and second uplink signals.

9. A method for communicating wellbore data, comprising:
transmitting a first uplink signal with a downhole transceiver coupled to a pipe string arranged within a wellbore, the first uplink signal corresponding to a first component of the wellbore data;
receiving the first uplink signal with a first repeater communicably coupled to the downhole transceiver;
transmitting the first uplink signal with the first repeater to a second repeater communicably coupled to the first repeater;
transmitting a second uplink signal with the downhole transceiver to the first repeater, the second uplink signal corresponding to a second component of the wellbore data;
receiving the first and second uplink signals with a surface transceiver in communication with the first and second repeaters, wherein the first and second uplink signals are simultaneously transmitted between the downhole transceiver and the surface transceiver and transmission of the first uplink signal successively precedes transmission of the second uplink signal.

10. The method of claim 9, wherein transmitting the second uplink signal further comprises separating the first and second uplink signals by one or more repeaters.

11. The method of claim 9, wherein transmitting the second uplink signal further comprises separating the first and second uplink signals by a single repeater.

12. The method of claim 9, further comprising:
determining with the downhole transceiver a size of the first uplink signal and a size of the second uplink signal;
determining with the downhole transceiver a data transmission speed of the first and second repeaters; and
determining with the downhole transceiver when the second uplink signal can be transmitted such that the first and second uplink signals do not collide in transit to the surface transceiver.

13. The method of claim 9, further comprising:
receiving the first and second uplink signals with the first and second repeaters across a first acoustic frequency; and
transmitting the first and second uplink signals with the first and second repeaters across a second acoustic frequency, the first acoustic frequency being different than the second acoustic frequency.

14. The method of claim 9, further comprising:
transmitting a first downlink signal with the surface transceiver;
receiving the first downlink signal with a third repeater communicably coupled to the surface transceiver;
transmitting the first downlink signal with the third repeater to a fourth repeater communicably coupled to the third repeater;
transmitting a second downlink signal with the surface transceiver to the third repeater;
receiving the first and second downlink signals with the downhole transceiver, the downhole transceiver being in communication with the third and fourth repeaters, wherein the first and second downlink signals are simultaneously transmitted between the surface transceiver and the downhole transceiver and transmission of the first downlink signal successively precedes transmission of the second downlink signal.

15. A method of communicating wellbore data, comprising:
transmitting a first uplink signal with a downhole transceiver to a plurality of repeaters communicably coupled to the downhole transceiver, the plurality of repeaters comprising individual repeaters axially spaced from each other along a length of a pipe string arranged within a wellbore;
successively transmitting the first uplink signal through the individual repeaters;
transmitting a second uplink signal with the downhole transceiver to the plurality of repeaters;
successively transmitting the second uplink signal through the individual repeaters, wherein the first and second uplink signals are simultaneously transmitted through the plurality of repeaters and transmission of the first uplink signal precedes transmission of the second uplink signal; and
receiving the first and second uplink signals with a surface transceiver in communication with the plurality of repeaters.

16. The method of claim 15, further comprising:
determining with the downhole transceiver a size of the first uplink signal and a size of the second uplink signal;
determining with the downhole transceiver a data transmission speed of each of the plurality of repeaters; and
determining with the downhole transceiver when the second uplink signal can be transmitted such that the first and second uplink signals do not collide in transit to the surface transceiver.

17. The method of claim 16, further comprising delaying the successive transmission of the second uplink signal at one or more of the individual repeaters such that the second uplink signal does not collide with the first uplink signal.

18. The method of claim 16, further comprising delaying the transmission of the second uplink signal from the downhole transceiver such that the second uplink signal does not collide with the first uplink signal.

19. The method of claim 15, further comprising separating the first and second uplink signals with a single repeater of the plurality of repeaters.

20. The method of claim 15, further comprising separating the first and second uplink signals with one or more repeaters of the plurality of repeaters.

21. The method of claim 15, further comprising:
receiving the first and second uplink signals with the plurality of repeaters across a first acoustic frequency; and
transmitting the first and second uplink signals with the plurality of repeaters across a second acoustic frequency, the first acoustic frequency being either the same or different than the second acoustic frequency.

22. A method of communicating wellbore data, comprising:
transmitting a first uplink signal with a downhole transceiver to a plurality of repeaters communicably coupled to the downhole transceiver, the plurality of repeaters comprising individual repeaters axially spaced from each other along a length of a pipe string arranged within a wellbore;
successively transmitting the first uplink signal through the individual repeaters while simultaneously transmitting a second uplink signal with the downhole transceiver to the plurality of repeaters, wherein transmission of the first uplink signal precedes transmission of the second uplink signal;
determining with the downhole transceiver a size of each of the first and second uplink signals and a data transmission speed of the first and second repeaters;
determining with the downhole transceiver when the second uplink signal can be transmitted such that the first and second uplink signals do not collide during transmission; and
receiving the first and second uplink signals with a surface transceiver in communication with the plurality of repeaters.
